(19) United States
(12) Patent Application Publication
(10) Pub. No.: US 2020/0211101 A1
(43) Pub. Date: Jul. 2, 2020

(54) Payment Holding and Disbursement Method

(71) Applicant: RACHEL REED, Fort Ann, NY (US)

(72) Inventor: RACHEL REED, Fort Ann, NY (US)

(21) Appl. No.: 16/729,364

(22) Filed: Dec. 28, 2019

Related U.S. Application Data
(60) Provisional application No. 62/786,291, filed on Dec. 28, 2018.

(51) Int. Cl. G06Q 40/02; G06Q 20/02; G06Q 20/10; G06Q 10/10; G06Q 20/40; H04L 29/06

(52) U.S. Cl. CPC G06Q 40/02; G06Q 20/02; G06Q 20/108; G06Q 50/182; G06Q 20/405; H04L 63/102; G06Q 10/10

(57) ABSTRACT

A method for guaranteeing funds from a buyer to a seller in conjunction with systematic disbursement of funds as buyer-seller agreements are satisfied. Buyer may transfer funds from a funding source into a third-party holding account which may be locked to prohibit funds from being removed by the buyer. This guarantees fund availability to the seller. The seller may be allowed to view funds in the holding account or may be notified that the amount meets the agreement amount established between the buyer and seller based on the criteria of the product or service being rendered. The buyer is offered the option to select how payment will be made to the seller. These options protect the buyer from relinquishing funds prior to the seller satisfying requirements established between the buyer and seller while systematically compensating the seller at appropriate times or stages in the parameters of the agreement. If the agreement reaches full completion, then the full agreed amount will be transferred to the sellers account. If the agreement is not fully satisfied the remaining amount may be returned to the buyer.

### CROSS-REFERENCE TO RELATED APPLICATIONS

The present application claims priority to U.S. provisional patent application Ser. No. 62/786,291, filed on Dec. 28, 2018. The entire disclosure is included herein in its entirety at least by reference.

### BACKGROUND OF THE INVENTION

### 1. Field of Invention

The present invention relates generally to financial transactions and more specifically to facilitating network-based financial transactions involving a method for holding and distributing funds with respect to selected handling and disbursement parameters, particularly those methods determined and controlled by an individual.

### 2. Related Art

In an economic environment where network-based payment processing is standard for both commercial and personal use, the need for heightened security is inarguable. Well-established internally regulated methods for online transaction security and convenient processing have become industry standards, increasing user confidence and satisfaction. However, externally controlled methods in the hands of the individual to safeguard funds are left unresolved.

The payment holding and disbursement method addresses the need for a process to safeguard the handling and disbursement of funds in commerce relationships, as seen in one embodiment, through third-party network-based technology. Currently, in a buyer-seller transaction, both parties are vulnerable to fraudulent practices with limited means of financial protection. The payment holding and disbursement method, when coupled with a network-based payment system, for example, may function to keep funds secure by inhibiting payment to a seller prior to service completion or product delivery without disintegrating the seller's confidence in receiving payment. This method would prevent fund withdrawal by the buyer securing funds in a holding account. In addition, the payment disbursement method of the invention may serve to systematically release funds efficiently to sellers, promoting effective and safe commerce practices for both sides of the transaction. Applied to a network-based payment application, for example, this method may yield a digital transaction diary as a ancillary benefit.

An example of one company utilizing network-based commerce is eBay Inc. eBay Inc. utilizes a method for the transfer of funds between two parties and acts as a third-party holding account and communication network. This system allows for funds to be obtained between parties in a few simple steps. The holding portion of this system allows funds to be held in escrow or a holding account for an unlimited number of days. The funds may be transferred to a financial institution or rendered as payment at any given time, provided there is fund availability in the eBay account. eBay Inc. uses internal mechanisms to relinquish payment from buyer to seller based on risk assessments. While this system has served as a means of avoiding fraudulent activity in certain buyer-seller situations, it is heavily based on risk assessments, internal controls, and transactions generated through network systems. These internal mechanisms are useful in eBay transactions, however in circumstances where the buyer is engaging with a seller from a place of vulnerability, either in person-to-person contact or through a network medium, there need for external controls that will safeguard their assets remains unresolved.

Person-to-person and online commerce relationships have a history of misuse by individuals seeking fraudulent gain. This challenge creates a market climate that reduces user confidence, thereby hindering market growth. Several areas of the financial market are presently beyond the era of hand-to-hand commerce transactions yet still require the same authenticity of rendering and receiving funds personally. In this place of vulnerability, financial transactions require specific measures to safeguard buyers and sellers from fraudulent transactions while also preventing misuse.

Currently in the financial market there are tangible payment bonds which allow for monies to be held and guaranteed in paper form. While these have been useful in the past, the process for retrieving these bonds is systematically flawed, requiring excessive time and procedures. These bonds are not frequently used in the marketplace and therefore only serve the minority of individuals who would assume the efforts in order to safeguard large financial stakes. In addition, these forms of payment are less common, so those with minimal exposure may not trust their use. In scenarios where payment guarantee is necessary a method is required to streamline transactions of any size through network-based third party management. The other significant differences between paper and network-based payment methods include—user-to-user viewing of account, simplicity of transferring funds, and no paper handling. In addition, if a buyer is paying multiple sellers for a project or service, the buyer may be required to procure multiple bonds, which would require increased handling efforts and organization. In addition, if the seller were to increase the amount owed due to any number of reasons, the buyer would have to either re-issue a new bond or purchase a second bond. Based on the payment holding and disbursement method, the buyer could, for example, simply increase the fund amount in the payment holding portion of the method for a particular seller with ease and minimal time.

### SUMMARY OF THE INVENTION

According to one embodiment, in a buyer-seller relationship, the need to harnesses network-based or other technologies that are capable of incorporating methods which assist commerce transactions pertaining to individualized handling is necessary. The details of how the payment holding and disbursement method encourages the safeguarding of funds and establishes a systematic method for fund release based on conditions outlined in a buyer-seller agreement, for example, are unique to this invention. A buyer-seller agreement relates to any transaction, spoken, written, or implied, between parties, referred to here as buyer and seller.

Utilization of this method may allow buyers to guarantee payment for products or services by securing funds in a holding account which may be locked and made visible to the seller(s). A locked account may prevent the buyer from extracting funds from the account until either a buyer-seller agreement is satisfied or dissolved. Viewing access may permit the buyer to confirm with seller funds are available. Agreement satisfaction might require the meeting of established or implied expectations and dissolution of agreement might result in an exit from the buyer-seller relationship. A buyer-seller relationship

Another embodiment of this invention includes the disbursement method of funds from a third-party network platform, for example, based on what may be a pre-established agreement between buyer and seller. The disbursement options within the method may include but are not limited to lump sum payment or payment in full, down payment followed by installment(s), percent-based or payment on progress, and rate-based. These options may allow a buyer and seller to establish a protocol for payment for a product or service.

Payment disbursement methods shall improve user confidence for both the buyer and the seller as funds are rendered systematically from a buyer account, for example, to a seller account. At the point of reaching a buyer-seller agreement, a payment holding account may be locked and therefore safeguarded from withdrawal prior to completion of a service or product(s) being rendered. A buyer-seller agreement may be any method of establishing expectations that a seller must satisfy in order to receive payment for product(s) or service(s). Expectations in the buy-seller agreement may be, but are not limited to, amount requested by seller for product or service, service or product description, time frame for services rendered to be completed or product to be delivered, and payment distribution details.

For example, a scenario may arise in which a service or product might require a structured time frame or development process. For the purposes of protecting the buyer, this method discourages full payment to a seller prior to satisfactory completion of the product or service. In addition, since payment is not provided in full to the seller at the start of the product or service, for purposes of protecting the seller, payment may be held in a locked account to ensure payment to the seller upon satisfactory completion of the product or service.

Reasons for applying the payment holding and disbursement methods to fund transfers between a buyer and seller(s) is to prevent dishonest practices by both parties. Buyer-seller relationships have been abused by fraudulent activity and miscommunicated expectations throughout history, thus creating distrust in the commerce setting. A negative experience may lead to distrust in future transactions for either party involved or potential avoidance of similar dealings all together. Distrust in people should not overwhelm a buyer or seller to avoid commerce in general. Instead, people must know they are protected and should be affirmed in such transactions to encourage present and future transactions. The locking of funds in a holding account empowers both buyers and sellers to pursue commerce relationships with confidence and optimism. The use of disbursement methods allows for the systematic payments from buyer to seller to be established at the beginning of the buyer-seller relationship and then streamlined and managed from one place.

Examples of buyer-seller scenarios may would justify use of a this invention are as follows but are not limited to these examples:

To protect a buyer, seeking a service or product, from being defrauded of funds by being misled by a seller. Based on a written, spoken, or implied agreement pertaining to the transaction, the service or product which was agreed upon may not have been completed, delivered, or was improperly done by the seller. In this scenario, the buyer is not satisfied by the results, yet all or a portion of funds may be lost if monies were given “in good faith” prior to the seller satisfying the written or spoken agreement.

Another scenario exists where a seller, who has satisfactorily completed a service or product agreement, is not justly compensated and thereby defrauded by the buyer, who had sought out the service or product and agreed to payment based on a written or implied arrangement. In this situation, the seller has lost out on profit, time, and possibly product whilst also having potentially limited means to recuperate the loss.

In either scenario, the individual or company facing the loss may then desire to seek justice through legal means which may demand excessive amounts of time and resources. In both situations, the adverse outcome may have been averted if a method was in place to set funds aside as an act of good faith where neither party could obtain funds until pre-established agreements are satisfied. As another measure of security and convenience, a systematic form of disbursement of funds may resolve the dilemma of total or partial loss of monies. A secondary benefit of this system exists in the digital trail it creates in establishing buyer-seller agreements and terms for product or service expectations as well as tracking payments that have been transferred. These forms of documentation may provide legitimate evidence and assistance in any legal claims by either party.

Additional benefits in the present invention stem from the guaranteed payment portion of the invention as seen in the locked account. The method of locking funds in a third-party holding account, a seller can be assured that payment is available and “waiting”. This may motivate seller(s) to complete agreement requirements and thereby accelerate results.

The method of disbursing payment allows for multiple payments to be made having been established ahead of time based on buyer-seller agreements which inherently offers protection to both buyers and sellers and is another layer of security relating to money handling. In many situations where payment is in the form of cash or check, handling such transactions is to the disadvantage of the buyer if the seller does not continue to satisfy agreement requirements and does not return undeserved funds. Coupled with any technology that may utilize the payment holding and disbursement methods invention, will effectively deter disreputable individuals seeking to acquire funds, services, or products without satisfying their portion of the buyer-seller agreement from engaging in fraudulent activity.

With the payment holding and disbursement method, both parties may participate in a contractual agreement whilst funds are protected until those agreements are satisfied. The payment holding accounts allow safeguarding of funds and the payment disbursement method establishes a systematic method for payment based on established parameters which should satisfy both parties while protecting both buyer and seller (this applies to any transfer of commerce or barter between parties using this method).

An example of a situation implementing the payment disbursement method is one in which a buyer contracts an independent contractor to remodel a home bathroom. The seller, who in this scenario is an independent contractor, may enter into agreement with the buyer to outline time frame and expectations for the work that will be done by the seller. In this scenario, the seller may agree to a payment disbursement option utilized through a third-party payment application, for example. If the seller agrees to a “payment on progress” option, for example, the seller may begin work by removing all pre-existing bathroom components thereby satisfying one of the agreement expectations and thereby meeting the requirement for the allocated fund amount for the specific action to be released to the seller account. This process would continue as agreement objections are satisfied until the all agreement expectations are met and the total amount of funds agreed to the seller is disbursed. A buyer-seller agreement may be outlined in the holding account parameters thereby establishing objectives and expectations between the buyer and seller. This situation is an example of one possible buyer-seller relationship in which the payment holding and disbursement methods may be implemented collectively.

In an economic environment where the number of commerce transactions is increasing daily, these methods coupled with the appropriate technology serve as tools for any individual engaging in commerce that are not only helpful but crucial for payment processing. Individuals who seek to improve the overall method of payment processing may use this system to streamline payments, thus garnering a professional yet personal appeal to those in a multitude of commerce settings.

### BRIEF DESCRIPTION OF THE FIGURES

Embodiments of the present invention are illustrated by way of example and not limitation in the following Figures of the accompanying drawings, in which like references indicate similar elements and in which:

FIG. 1 illustrates a network system, according to an example embodiment of the present invention, having a client-server model.

FIG. 2 illustrates a block diagram demonstrating an application server in an example embodiment of the present invention with the central holding account and payment disbursement applications, respectively.

FIG. 3 illustrates, in an example embodiment, a flow diagram of a procedure for establishing the central holding account(s) and sub account(s).

FIG. 4 illustrates, in an example embodiment, a flow diagram of a procedure for accessing established sub account(s) and determining parameters for viewing access, locking the sub account, and initiating the payment disbursement tool.

FIG. 5 illustrates, in an example embodiment, a flow diagram of a procedure for assigning payment disbursement methods and requirements for fund release.

### DETAILED DESCRIPTION OF THE INVENTION

This invention is a payment holding and disbursement method whose parts may function complimentarily or independently. The payment holding and disbursement methods may be launched in a payment application coupled with a network system but method implementation should not be limited to these technologies. This invention is structured to be accessible whenever and wherever commerce is achievable. Various aspects of the system are customizable per user or client specification.

In the following description, for the propose of explanation, a multitude of specific details are discussed in order to establish a thorough understanding of the embodiments of the present invention.

Embodiments of the present invention illustrate a method to systematically distribute payment to a seller via a network-based payment platform. The method includes establishing a secure central holding account(s) and sub account(s), which may be locked in order to prevent fund withdrawal and thus guarantee payment. In addition, sellers may be able to view holding account status for proof of funds as well as implement a systematic disbursement of funds from the buyer to the seller.

Embodiments of the present disclosure enable a buyer to place funds in a holding account with, for example, an online payment provider which by choice may be locked to inhibit withdrawal. Upon acquiring an agreement with a seller in which the agreement guarantees payment via locked holding account, the funds may not be withdrawn until the agreement is satisfied or dissolved. Furthermore, example embodiments herein present payment disbursement options which may be customizable based on buyer-seller agreement conditions.

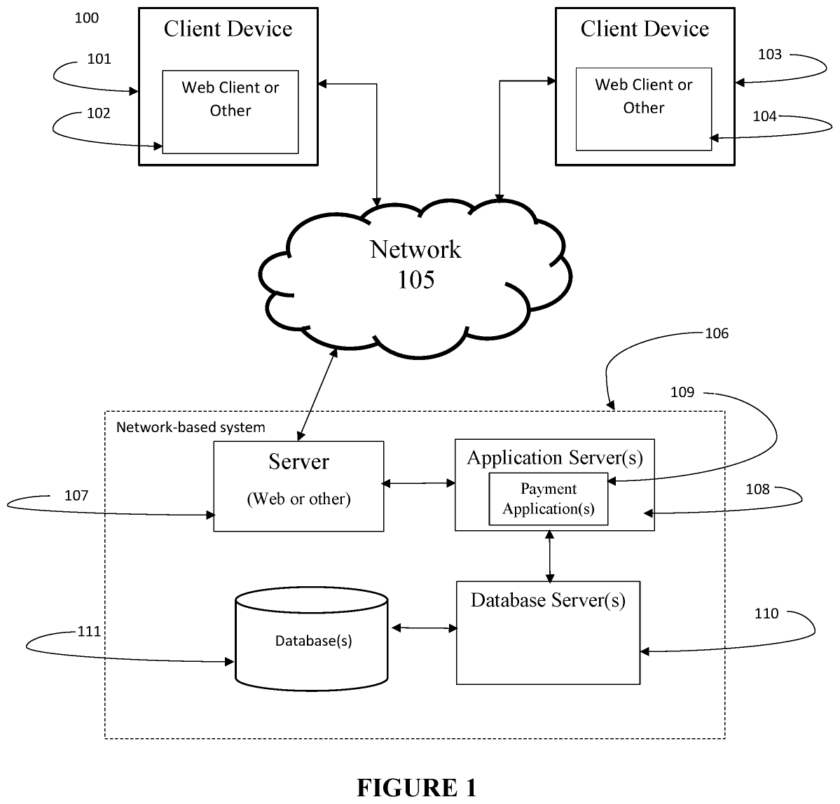

FIG. 1 represents, in an example embodiment of the present invention, a network diagram 100 illustrating a system having a client-server architecture which includes client device(s) 101,103, client 102,104, and a network-based system 106 connected via a network 105. Statues of this invention are not intended to be limited by means of this architecture and should be seen as examples of how this invention may be utilized.

The network 105 may, for example, be the Internet, telephone system, or any other technology linking the client(s) 102,104 and the network-based system 106. The network 105 access should result in communication between client and payment application(s) 109 with respect to database server(s) 110 and database(s) 111.

The client device may, for example, include any machine or system that gains access to the to the network-based system 106 such as a personal electronic device, tablet, cellular phone, laptop computer, desktop computer, or land-line telephone, for example.

FIG. 1 also illustrates that the client may, for example, be any web browser or network-accessing system that might operate on the client device 101,103.

The client 102, 104 may utilize network servers 107 to gain access to the application server 109. Payment applications 111 stored in a network database 110 may be accessed via database server(s) 109. Elements 107, 108, 109, 110, and 111 are part of a Network-based System 106. Users 102,104 are presented here as a buyer and a seller as a means of representing a transaction between two parties where funds are transferred from one person to another. The buyer-seller relationship and terminology should not limit the invention as it is intended for any transaction between users.

While the system 100 in FIG. 1 utilizes a client-server architecture, embodiments are not limited to such architecture, and utilization may apply to a multitude of other systems that exist currently or that may be developed.

The payment application(s) 109 may have access to the database 111 through, for example, the database server(s) 110. Database server(s) 110 may support one or more user accounts on device application 101, 103.

Payment application(s) 109 may be structured to accommodate multiple transactions to multiple sellers per each user account. Payment application(s) 109 may allow, for example, central account(s) with an unlimited number of holding accounts. These holding accounts may be connected with a seller's user account and thereby provide the conditions for a buyer-seller commerce transaction. Such conditions are not required but may be available. The payment application(s) 109 may, for example, receive funds from an external funding source such as a financial institution, third-party payment platform, credit card, electronic check, or debit card or from within the payment application(s) 109. The types of funding listed here should not limit funding sources but merely be seen as examples.

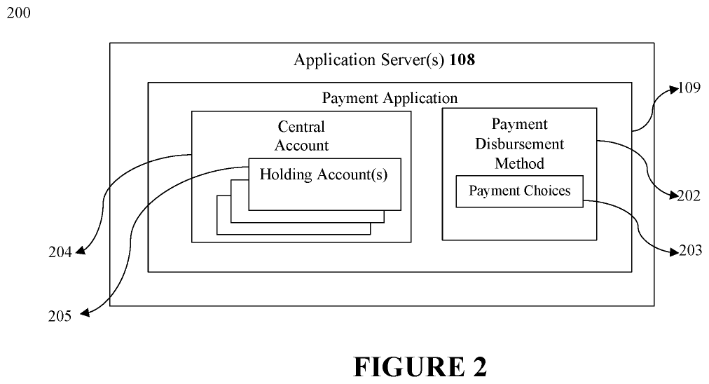

FIG. 2 represents, in an example embodiment, a block diagram 200 illustrating the application server 108 and payment application 109. Components of the payment application 109 include central account(s) 204 with respective holding account(s) 205, and payment disbursement method 202 with respective payment choices 203.

The user may access the payment application 109 using, for example, the network system 100 and thereby gain access to the central account(s) 204 and payment disbursement method 202 and their respective components. The listing of payment application 109 components is not intended to limit the number of elements, but rather to focus on and illustrate the functionality of the central account(s) 204 and payment disbursement method 202.

The central account(s) 204 and respective holding account(s) 205 may be utilized as payment application methods whereby users might store funds or commerce in a third party payment application. The holding accounts 205 are distinct entities that function under the central account(s) 204. Holding accounts 205 may be treated as independent accounts and thereby serve to designate funds to specific sellers. There is no limit to the number of holding accounts 205 that may be associated to each central account 204. In this way, the central account(s) 204 may retrieve any amount of funds from a funding source and allocate any specific amount of those funds up to the total amount in the central account 204 into individual holding accounts 205.

Users may not be limited to a single central account 204, this example embodiment is intended to depict the function of a central account 204 and the respective holding accounts 205 associated with it. This is not intended to limit the current invention but to convey the systematic method of holding funds and allocating a portion or all funds into the holding account(s) 205.

Also illustrated in FIG. 2 is the payment disbursement method 202. The payment disbursement method 202 may be utilized as payment transfer method that systematically disburses payment between users based on chosen parameters established by selecting a payment choice 203 in a network-based third-party payment application, for example. The payment disbursement method is acknowledged as separate and distinct from the central account(s) 204 and holding account(s) 205 but may work in correlation with the central 204 and holding 205 accounts as a means of payment transfer.

Illustration of two methods, the central account 204 and payment disbursement 202, should not limit the number of functions that a payment application 109 is capable of utilizing.

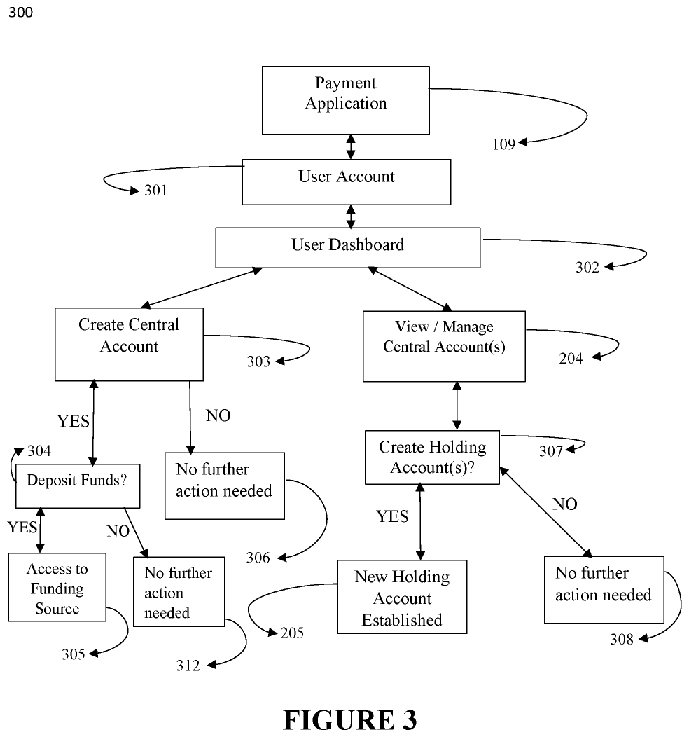

FIG. 3 illustrates, in an example embodiment 300, a flow diagram of a procedure for establishing the central account(s) 204 and holding account(s) 205. By accessing the payment application 109 using a network-based system 106 coupled with a network 105, the user 101 may create a user account 301. The user account 301 is a secure account whereby access is granted to the central account(s) 204 and payment disbursement 202. The user account 301 may require the user 101 to create a unique identifier and password or utilize other technologies such as fingerprint analysis, for example. In this example embodiment, creating a user account 301 and the process for establishing unique identifiers per individual user is not intended to limit the invention but illustrate the unique nature and secure personal environment of each user account harnessing protective measures to safeguard sensitive information. Users may be able to create multiple user accounts 301. A user account 301 is any unique method of access allowing the user to interact with the payment application 109.

Once the user account 301 is established, the user may gain access to the central account(s) 204 associated with the respective individual user account 301. The user 101 may setup a central account 204 by engaging an option panel referred to a user dashboard 302 which may offer selections such view/manage central account 204 and create a central account 303, for example. The user may choose to create a central account 303. The newly established central account 204 may then automatically appear when the user logs into the user account. A user account may exist without a central holding account 306, and no further action is needed at that time.

Once established, the user may choose to deposit funds 304 into the central account 204. Central accounts 204 may access funds from single or multiple funding sources 305 including but not limited to financial institutions, third-party payment, credit card, debit, electronic check, or other central accounts 204 or holding accounts 205. Access to funding source(s) describes any means of communication between a funding source and the payment application whereby the result is the transferring or moving of funds (or equally acceptable form of commerce) to the central account 204.

The user may also choose to associate certain central accounts 204 with specific or separate funding sources and would be able to do so with multiple central accounts 204. The term deposited should broadly indicate that funds have been moved from one funding source into a central account 204. The available fund amount in central account(s) 204 may be displayed for viewing purposes and convenience when the user account 301 is accessed. Funds may be in the form of any currency or credit that can function as a tool to exchange for goods or services within the payment application parameters or in conjunction with external payment applications. The user may decide not to transfer funds or to delay transferring at the time of creating the central account 204, in this case no further action is needed 312. Central accounts 204 may exist without a positive fund status or a zero balance.

FIG. 3 also illustrates holding accounts 205 which may be utilized to enhance the actions of the central account(s) 204 by organizing funds and transactions into smaller accessible bundles thereby allowing easier management of funds when conducting commerce with multiple sellers or for multiple services or products, for example. The user may navigate options within or associated with a central account 204 that allow the user to create a holding account 205. Should the user choose to create a new holding account 307, the holding account 205 will then be associated with the central account 204 under which it was established. There may be no limit to the number of times that a user may choose the option to create a holding account 307. The user may choose not to create a holding account in which case no further action in required 308 at that time.

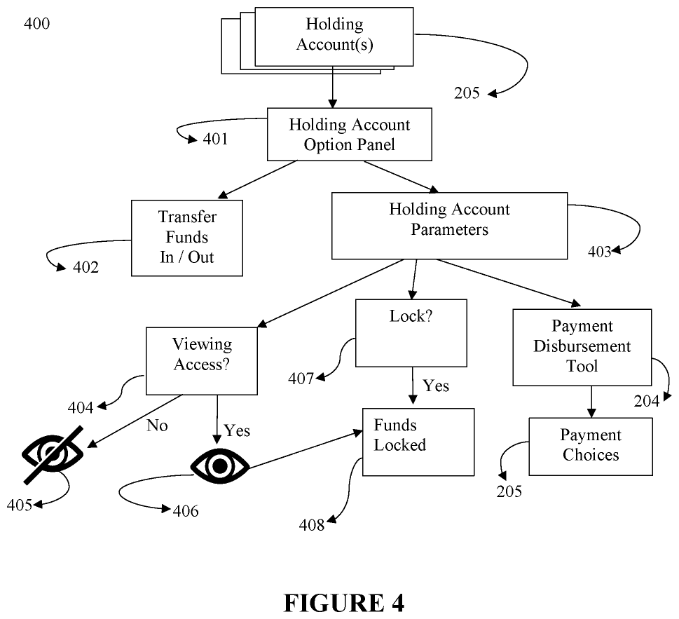

FIG. 4 illustrates, in an example embodiment, a flow diagram 400 of a method for accessing established holding account(s) and determining parameters for viewing access 404, locking 407, and initiating payment disbursement 204. User may access holding account(s) 205 by way of an associated central account 204, however this is one mode of access and is not intended to limit the invention or the methods of accessing holding account(s) 205.

Access to the holding account(s) 205 may provide the user a selection panel 401 or range of options to manage or further establish the holding account including, but not limited to, the option to transfer funds 402 into a selected holding account 205 and to establish parameters for the holding account 403. The transfer of funds may be sourced from the central account 204 associated with the selected holding account, however this is not intended to limit the invention, and funding source should not be restricted to the central holding account 204. Funds may be deposited into the holding account 205 directly from an external funding source or other third-party payment application, thus allowing the holding account(s) 205 access to funding source(s) 420 independently from the central account 204.

Holding accounts 205 may access funds from single or multiple funding sources 305 including but not limited to financial institutions, third-party payment applications, credit card, debit, electronic check, or central account 204. Access to funding source(s) describes any means of transmission between a funding source and the payment application whereby the result is the transferring or moving of funds or equally acceptable form of commerce to the holding account 205.

The user may also choose to associate certain holding accounts 205 with specific or separate funding sources and would be able to do so with multiple holding accounts 205. The term deposited should broadly indicate that funds have been moved from one funding source into a holding account 205. The available fund amount in holding accounts 205 may be displayed for viewing purposes and convenience when the user account 301 is accessed. Funds may be in the form of any currency or credit that can function as a tool to exchange for goods or services within the payment application parameters or in conjunction with external payment applications. The user may decide not to transfer funds or to delay transferring at the time of creating the holding account 205, in this case no further action is needed. Holding accounts 205 may exist without a positive fund status or a zero balance.

In transferring funds 402, the user may decide to move funds out of the holding account 205 into the central account 204. Other transfer options 402 may be available related to the holding account 205 and should not be limited to the example embodiment, as it is intended to represent the flexibility and fluidity of transfer capabilities.

The term manage is intended to broadly describe any process or operation that will alter or affect the holding accounts relating to user controls.

FIG. 4 also illustrates the permissions granted that outline the parameters of the holding account 403 as related to viewing access 404 to the seller, locking 407, and payment disbursement 202. The holding account parameters 403 may be outlined in respect to a buyer-seller agreement, for example, which may be preset in the payment application or parameters may be by-passed. The function of the holding account parameters 403 is to establish clearly outlined expectations between the user and seller. These expectations will enhance payment disbursement 202 by providing objectives and expectations to be met. This method of establishing parameters may be by-passed by the user and is not required for granting permissions or managing holding account 205.

A component of the holding account 205 may be permitting viewing access 404 to the holding account 205. With viewing access, the user may verify fund availability to the seller. The user may have the option to allow viewing access 406 or not allow viewing access 405. The term to view is intended to describe having access to fund availability, including but not limited visually, audibly, or any other mode of communication to the seller for the selected holding account 205. Viewing access 406 will not affect security associated with the user account. Viewing capabilities will grant access to the seller to confirm that the buyer holding account 205 has the expected amount of funds available. The funds expected by the seller relates to any agreed upon amount established in buyer-seller communications.

A second element of managing a holding account 205 may be activation of a locking control 411. A locking control may be intended to prevent buyer from withdrawing funds from the holding account 205 until established objectives or expectations are satisfied or dissolved. Additional examples permitting the release of funds include, but are not limited to, partial release or no release until a dispute between buyer and seller is resolved. The buyer may decided not to lock the holding account 205, then no further action is needed 412. The method of locking a holding account 205 should be contained within the selected holding account 205 as locking preferences are specific to individual holding accounts. Locking of an individual holding account 205 should not alter the accessibility of other holding accounts or central account(s) 204. Buyer controls within the payment application 109 may allow locking of the central account(s) 204 independent of holding account(s)205, however the relationship of locking between the central account 204 and holding accounts 205 should not be limited in any way.

If buyer selects to lock the holding account 205 after parameters are established 403 and the seller does not satisfy the objectives or expectation set forth or satisfies only a portion of the details, then the buyer may release a portion of the funds or withhold all funds. It may be up to the buyer and seller to resolve the dispute, should one exist, or the seller may depart from the transaction and the funds may automatically be released to the buyer and the holding account 205 may be unlocked.

Buyer may choose to maintain funds in an unlocked holding account 205. Locked simply means that the buyer cannot extract funds from the selected holding account 205 especially once an agreement with a seller has been set in the holding account parameters 403. Locking 405 is not a required parameter for the holding account 205 to be accessed for payment to be released to the seller. Buyer may choose to hold the bulk of their funds in a secure unlocked central account 204 or holding account 205 and transfer funds as needed to a locked holding account 205. Payment disbursement 202 may be made from either a locked or unlocked holding account 205 to the seller.

A third element of the holding account(s) 205 illustrated in FIG. 4 addresses payment disbursement 202. Access may be given to through payment disbursement 202 through the holding account 205, however there may be other methods for achieving access to payment disbursement including, but not limited to, access through the central account(s), payment application, application server, separate applications, directly through devices, or other process whereby payment disbursement method 202 may be utilized. Payment disbursement 202 may allow the buyer to select method(s) for fund disbursement 203.

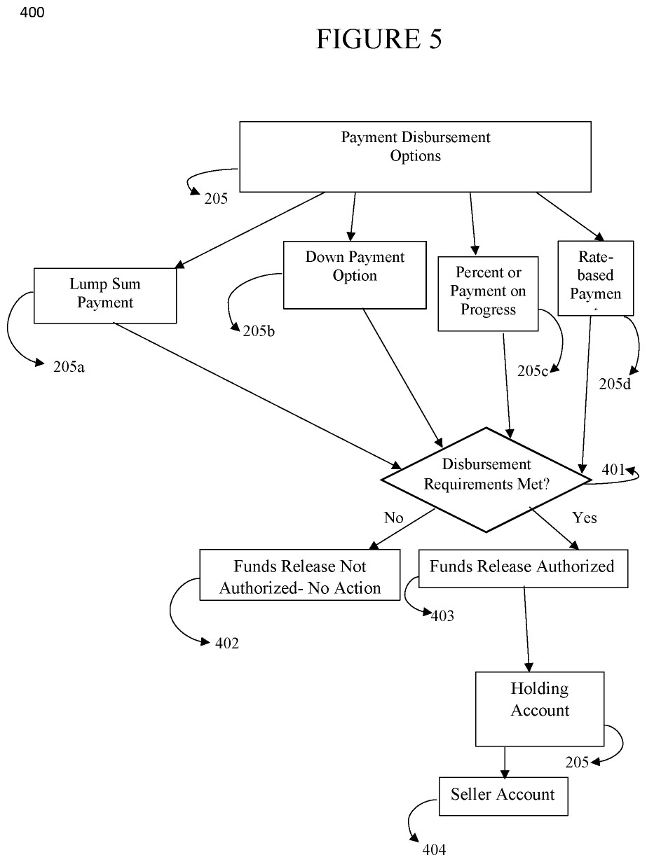

FIG. 5 illustrates, in an example embodiment 500, a flow diagram of a process for utilizing payment disbursement methods 202 and options for fund release 203. Buyer may choose a payment option 203 for a selected holding account 205 whereby they may disburse funds to a seller in a structured manner. Payment methods include, but are not limited to, the preference of payment in full 203a, down payment 203b, percent or payment on progress 203c, and hourly payment 203d. Payment disbursement methods 203 may occur, for example, at the discretion of the buyer or in established parameters 403 but are not limited to these factors.

The payment in full option 203a describes a method whereby the buyer may disburse funds to the seller in a single payment.

The down payment option 203b describes a method whereby the buyer may disburse funds to a seller as an initial payment of any amount followed by any number of payment installments over time.

The percent-based payment or payment on progress option 203c describes a method whereby the buyer may disburse funds to a seller in allotted amounts. Percent-based or payment on progress 203c disbursements may be based on seller performance or progress associated regarding a product or service, for example. Additionally, percent-based and payment on progress may be based on the ability of the seller to satisfy specific objectives related to product or service development or completion.

The rate-based payment option 203d describes a method whereby a buyer may disburse funds to a seller based on a fee structure. A rate-based payment method 203d may be established by the seller or agreed upon in the buyer-seller agreement, for example, and the factors influencing the rate-based method 203d might be adjusted to accommodate specific conditions. Rate-based payment 203d, for example, may be allotted daily, weekly, based on progress or hours worked. Combinations for a rate-based payment method 203d offer a flexible payment method for a variety of buyer-seller relationships.

Payment disbursement options 203 illustrated in FIG. 5 describe a method of systematically releasing funds or commerce based on controls the buyer may establish possibly with respect to seller feedback. Upon disbursement requirement being met 501, fund release is authorized 501, and the holding account 205 are transferred to the seller account 504. If disbursement requirements are not met, fund release is not authorized and no action occurs 502. The distinct relationship between payment disbursement 202 and the holding account 205 is the necessary requirements 501 being met by the seller in order for funds to be released or transferred into the seller account 504.

The foregoing disclosure and illustrations of embodiments described herein are not intended to limit the present invention to the precise forms and terms used to detail the present invention. Embodiments are intended to provide a general understanding of the methods and possible applications to which they may be utilized. Terms such as “buyer”, “seller”, “agreements”, “relationship”, “online”, and “network-based system” are examples applying to certain embodiments but are not intended to limit the accessibility of the invention through other technologies nor the persons to which the invention may serve.

Embodiments of the inventions described herein should allow persons of ordinary skill in the art to recognize that changes may be made in form and detail without departing from the scope of the invention. FIGS. 1-5 are merely representational and the elements, order of operations, and processes may be varied to suit particular applications. Part of some embodiments may be included in or substituted for those of other embodiments. Thus, the invention is limited only by the claims with each claim standing as its own embodiment. It will be evident that various modifications and changes may be made to these embodiments without departing from the broader scope and nature of embodiments as described in the claims.

1. A method for facilitating an online transaction, comprising:
transferring funds or other commerce to a holding account;
allowing holding account to be locked, whereby buyer agrees to surrender withdrawal privileges thereby inhibiting withdrawal;
allowing viewing access, related to holding account locked status and verification of fund availability, may be granted to the seller

2. A method of claim 1, wherein the buyer may lock the holding account and funds may not be withdrawn

3. A method of claim 1, wherein parameters established by buyer are satisfied or dissolved in order for funds to be released from the holding account.

4. A method of claim 1, wherein funds in the holding account may be disbursed systematically by way of user-selected protocols, comprising:
payment on progress or percent-based payment whereby disbursement occurs in increments or are scheduled;
payment in full, whereby disbursement occurs in a single payment;
down payment, whereby disbursement occurs as an initial payment based on a portion of the total amount owed followed by any number of installments;
rate-based payment, whereby disbursement may be based on a fee structure to accommodate flexible arrangements.

5. A method of claim 1, whereby the lock on the holding account may be relinquished in situations where agreement has been satisfied or dissolved between users.

6. A method of claim 1, wherein the ability to remove funds from holding account is permitted after a lock is established up until written, spoken, or implied agreements are instituted and then satisfied in part or in full or agreements are dissolved

7. A method for facilitating an online transaction, comprising:
systematic disbursement of funds or other resources by way of user-selected protocols including but not limited to:
payment on progress or percent-based payment whereby disbursement occurs in increments or are scheduled;
payment in full, whereby disbursement occurs in a single payment;
down payment, whereby disbursement occurs as an initial payment based on a portion of the total amount owed followed by any number of installments;
rate-based payment, whereby disbursement may be based on a fee structure to accommodate flexible arrangements.

8. A method of claim 7, wherein buyer may establish an agreement which may be written, spoken, or implied with seller to select a payment disbursement method.

9. A method of claim 7, wherein payment disbursement method is chosen and applied to the buyer account.

10. A method of claim 7, wherein buyer accepts the payment disbursement method and payments are withdrawn from the buyer account and transferred to the seller

11. A method of claim 7, wherein transfers made from buyer account to seller account may be processed until agreements are satisfied, payment is made in whole, agreements are dissolved, or a dispute is made.

12. A method of claim 7, wherein any variation from the standard or ideal situation whereby all agreements are not satisfied and payment is not made in full to seller may be handled through any number of actions to resolve and disputes or disagreements between buyer and seller and users and application methods.

13. A method of claim 7, wherein seller may submit requests to modify agreed criteria pertaining to amount owed for product or service or other statutes of the buyer/seller agreement. Such requests must be approved by the buyer.

14. A method of claim 7, wherein the buyer may modify agreed terms by altering the payment holding, disbursing, or viewer settings. Such actions may be approved by the seller.

15. Parameters established in regard to claim 7 may be any set of objectives or expectations set by the buyer independently or in conjunction with the seller that establishes a protocol for meeting requirements that will allow for funds to be disbursed from the holding account to the seller account.
